(19) United States
(12) Patent Application Publication
(10) Pub. No.: US 2023/0394038 A1
(43) Pub. Date: Dec. 7, 2023

(54) Dynamic Knowledgebase Generation with Machine Learning

(71) Applicant: ServiceNow, Inc., Santa Clara, CA (US)

(72) Inventors: Saeideh Shahrokh Esfahani, Santa Clara, CA (US); Thangavel Viswam, Santa Clara, CA (US); Abhijay Jayaswal, Hyderabad (IN); Dilnasheen Muhammad, Sydney (AU)

(21) Appl. No.: 17/831,072

(22) Filed: Jun. 2, 2022

(51) Int. Cl. G06F 16/242; G06F 16/28

(52) U.S. Cl. CPC G06F 16/243; G06F 16/285; G06N 20/00

(57) ABSTRACT

A system includes a machine learning model configured to, based on textual representations of queries, classify the queries among query intents, which may be mapped to predetermined solutions to problems. The system also includes a software application configured to receive a query that includes a textual representation of a problem, and generate, by the machine learning model and based on the textual representation of the query, a query intent therefor. When the query intent is determined to be one of the query intents mapped to a predetermined solution, the predetermined solution for the query may be selected from the predetermined solutions based on the mapping. When the query intent is determined to be a no-solution query intent, the query may be added to a no-solution query set and, when this set accumulates a threshold number of queries, a solution to the problem may be requested from a technician.

### BACKGROUND

Technical documentation may describe solutions to various technical problems that might be encountered by users within a computer network. However, when the technical documentation is long, poorly organized, and/or poorly written, it may be difficult to identify a solution to a particular problem using such technical documentation. Thus, users may avoid referencing the technical documentation, and may instead submit the problems to be resolved by technicians. Similarly, technicians that are unable to find the solution may reassign the problem to yet other technicians, thereby involving multiple technicians in the resolution of a single problem.

### SUMMARY

A user within a computer network may experience a technical problem, and may seek assistance with solving this technical problem by submitting a query that includes a textual description of the technical problem. A software application may be configured to determine, using a machine learning model, a solution to the query. Specifically, the machine learning model may be configured to determine, based on the textual description of the technical problem, a query intent for the query. The machine learning model may be configured to map, to the query intent, various possible textual descriptions of the problem, and the query intent may thus provide a representation of the problem that is independent of the specific textual phrasing chosen by a given user.

The machine learning model may be configured to select the query intent from a plurality of query intents, each of which may be associated with a corresponding predetermined solution. The association of a particular solution with a given query may indicate that that problem has been previously solved, and that the particular solution represents a valid and/or verified procedure for resolving the problem represented by the given query, rather than the particular solution merely containing, for example, information that may be relevant and/or similar to the given query.

The machine learning model may additionally be configured to generate, for some queries, a no-solution query intent that represents problems for which a predetermined solution is not available. That is, the machine learning model may be configured to distinguish between queries for which predetermined solutions are available, and queries for which a respective predetermined solution has not yet been provided. Thus, the machine learning model may be explicitly configured to avoid assigning, to a query with no predetermined solution, one of the plurality of query intents associated with predetermined solutions. The machine learning model may instead be configured to explicitly indicate, by generating the no-solution query intent, that a predetermined solution for the query is not available.

The software application may be configured to, for a query associated with a query intent that has been mapped to a predetermined solution, retrieve and provide the predetermined solution. When a query is assigned the no-solution query intent, the software application may instead be configured to add this no-solution query to a no-solution query set. When the no-solution query set and/or a cluster of related no-solution queries within the no-solution query set accumulates at least a threshold number of queries, a solution to these queries and a new query intent corresponding to this solution may be requested from a technician. The software application may be configured to obtain the solution and the new query intent, thus allowing the machine learning model to be retrained based on the threshold number of queries, the solution thereto, and the new query intent. In one example, the threshold number may be selected to provide a sufficient number of training samples for retraining the machine learning model to additionally include the new query intent as a potential output. Thus, over time, the number of query intents and corresponding solutions may increase.

In some implementations, execution of the machine learning model may be triggered by a request for reassignment of the query from one technician to another. Specifically, the software application may be configured to receive the query and, based on, for example, a problem class of the query, assign it to a technician expected to be able to provide a solution to the problem. In some cases, the technician may be unable to provide the solution to the problem, and may thus request, using the software application, to reassign the query to another technician. For example, the technician might not know the solution and/or might be unable to find the solution in documents that describe a plurality of different solutions to a plurality of different problems.

Reassignment of queries between technicians may be undesirable, especially when the solution to the problem is available in documentation that is accessible to the technician. For example, a reassigned query may be reviewed by multiple technicians, with only one of them actually developing and/or providing the solution thereto, thereby unnecessarily expending technician resources. Additionally, query reassignment may increase the user's wait time for the solution. Further, when the query is resolvable by the technician, but is instead reassigned to a more skilled technician, the resources of the more skilled technician are unnecessarily expended on a problem that should have been resolved by a less skilled technician.

Thus, in response to reception of the request to reassign the query to another technician, the software application may be configured to provide the textual description of the problem as input to the machine learning model. When the machine learning model assigns, to the query, a query intent associated with a predetermined solution, the predetermined solution maybe provided to the technician instead of reassigning the query. By providing the predetermined solution to the technician, the likelihood of the technician resolving the problem without reassignment of the query may be increased. When the machine learning model assigns, to the query, the no-solution query intent, the query may be reassigned as requested, since a predetermined solution to the problem is likely unavailable, and involvement of another, possibly more skilled, technician may be warranted.

Accordingly, a first example embodiment may involve a system that includes persistent storage, a machine learning model, and a software application. The persistent storage may be configured to store a mapping of (i) a plurality of query intents to (ii) a plurality of predetermined solutions of a plurality of problems. The machine learning model may be configured to, based on textual representations of queries, classify the queries among (i) the plurality of query intents and (ii) a no-solution query intent representing one or more problems for which the mapping does not include a corresponding predetermined solution. The software application may be configured to perform operations. The operations may include receiving a query that includes a textual representation of a problem, and generating, by the machine learning model and based on the textual representation of the query, a query intent for the query. The operations may also include, when the query intent is determined to be one of the plurality of query intents, (i) selecting, based on the mapping and the query intent, a predetermined solution for the query from the plurality of predetermined solutions and (ii) providing the predetermined solution. The operations may further include, when the query intent is determined to be the no-solution query intent, (i) adding the query to a no-solution query set and (ii), when the no-solution query set accumulates at least a threshold number of queries, requesting, from a technician, a solution to the problem.

A second example embodiment may involve receiving a query that includes a textual representation of a problem. A mapping of (i) a plurality of query intents to (ii) a plurality of predetermined solutions of a plurality of problems may be stored in persistent storage. The second example embodiment may also involve generating, by a machine learning model and based on the textual representation of the query, a query intent for the query. The machine learning model may be configured to, based on textual representations of queries, classify the queries among (i) the plurality of query intents and (ii) a no-solution query intent representing one or more problems for which the mapping does not include a corresponding predetermined solution. The second example embodiment may additionally involve, when the query intent is determined to be one of the plurality of query intents, (i) selecting, based on the mapping and the query intent, a predetermined solution for the query from the plurality of predetermined solutions and (ii) providing the predetermined solution. The second example embodiment may further involve, when the query intent is determined to be the no-solution query intent, (i) adding the query to a no-solution query set and (ii), when the no-solution query set accumulates at least a threshold number of queries, requesting, from a technician, a solution to the problem.

A third example embodiment may involve receiving (i) a first query that includes a first textual representation of a first problem and (ii) a second query that includes a second textual representation of a second problem. A mapping of (i) a plurality of query intents to (ii) a plurality of predetermined solutions of a plurality of problems may be stored in persistent storage. The third example embodiment may also involve generating, by a machine learning model, (i) a first query intent for the first query based on the first textual representation and (ii) a second query intent for the second query based on the second textual representation. The machine learning model may be configured to, based on textual representations of queries, classify the queries among (i) the plurality of query intents and (ii) a no-solution query intent representing one or more problems for which the mapping does not include a corresponding predetermined solution. The third example embodiment may additionally involve, determining that the first query intent is one of the plurality of query intents and, in response, (i) selecting, based on the mapping and the first query intent, a predetermined solution for the first query from the plurality of predetermined solutions and (ii) providing the predetermined solution. The third example embodiment may further involve, determining that the second query intent is the no-solution query intent and, in response, (i) adding the second query to a no-solution query set and (ii), when the no-solution query set accumulates at least a threshold number of queries, requesting, from a technician, a solution to the second problem.

In a fourth example embodiment, an article of manufacture may include a non-transitory computer-readable medium, having stored thereon program instructions that, upon execution by a computing system, cause the computing system to perform operations in accordance with the first, second, and/or third example embodiment.

In a fifth example embodiment, a computing system may include at least one processor, as well as memory and program instructions. The program instructions may be stored in the memory, and upon execution by the at least one processor, cause the computing system to perform operations in accordance with the first, second, and/or third example embodiment.

In a sixth example embodiment, a system may include various means for carrying out each of the operations of the first, second, and/or third example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 depicts a machine learning system, in accordance with example embodiments.

FIGS. 7A, 7B, and 7C contain message flow diagrams, in accordance with example embodiments.

FIG. 8 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. Example Computing Devices and Cloud-Based Computing Environments

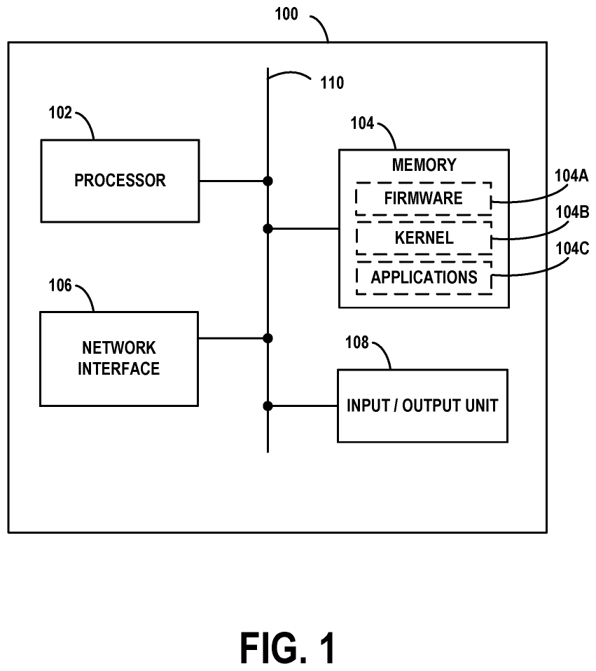

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

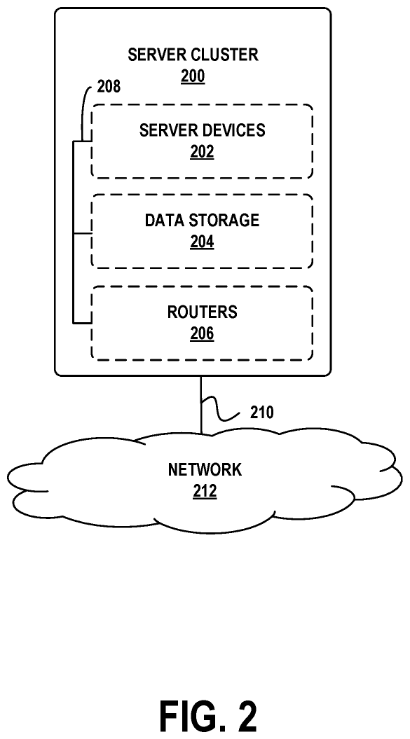

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, the eXtensible Markup Language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. Example Remote Network Management Architecture

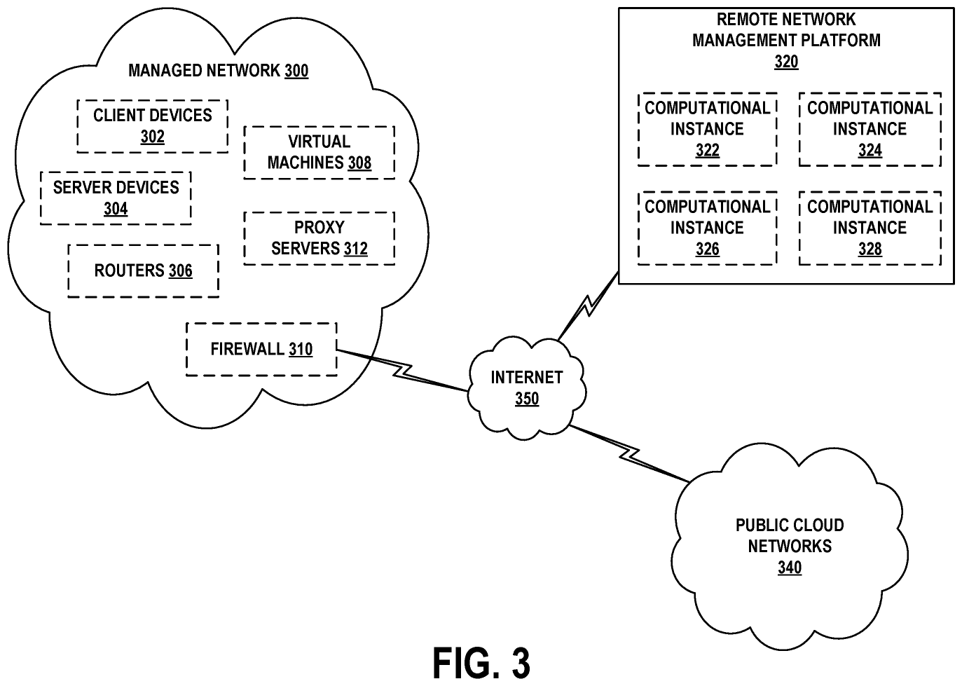

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include AMAZON WEB SERVICES® and MICROSOFT® AZURE®. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

D. Communication Support and other Operations

Internet 350 may represent a portion of the global Internet. However, Internet 350 may alternatively represent a different type of network, such as a private wide-area or local-area packet-switched network.

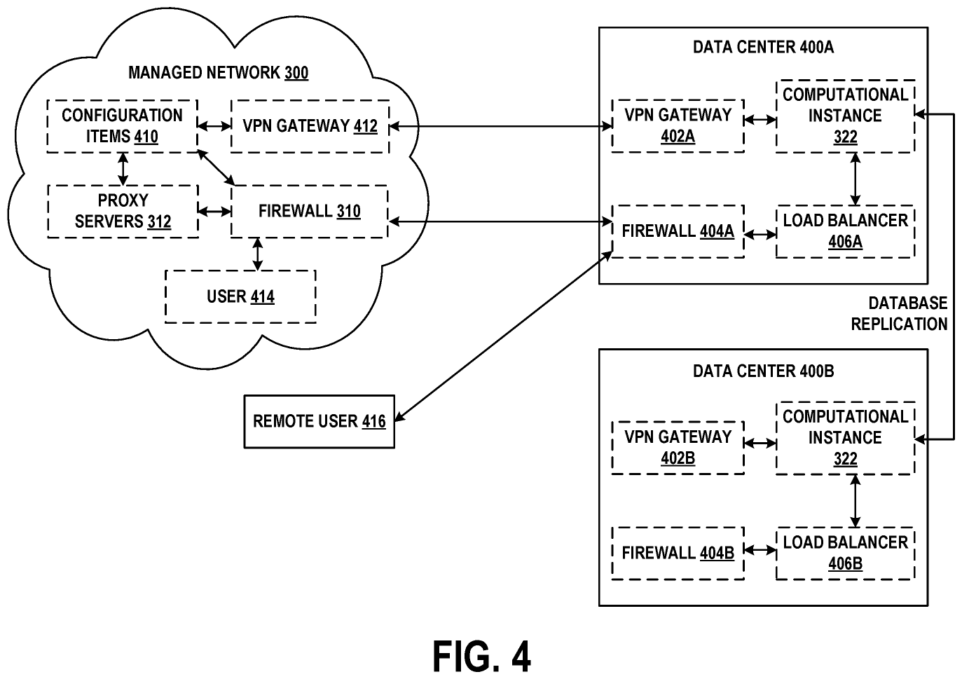

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### IV. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of each device, component, application, and service may be referred to as a configuration item. The process of determining the configuration items and relationships within managed network 300 is referred to as discovery, and may be facilitated at least in part by proxy servers 312. Representations of configuration items and relationships are stored in a CMDB.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

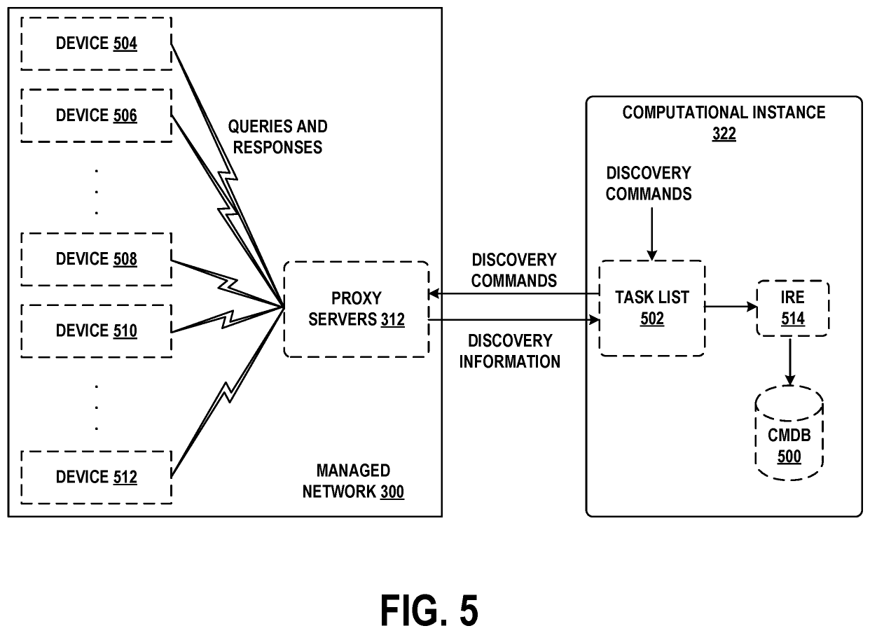

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery —horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases—under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### V. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VI. Example Machine Learning System

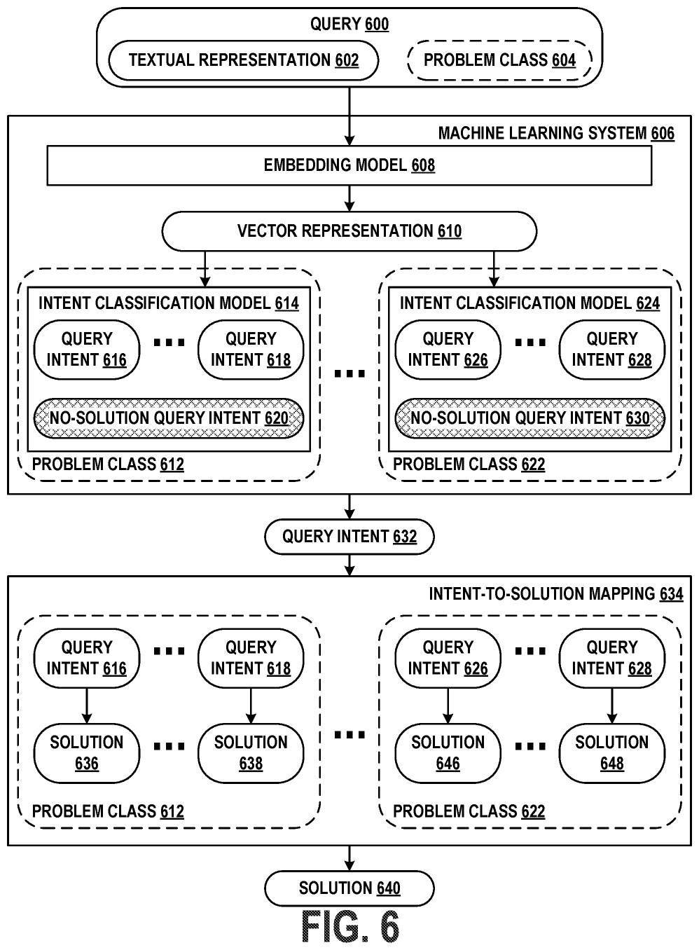

FIG. 6 illustrates an example system that may be used to facilitate identification of solutions to problems described in user-submitted queries. Specifically, the example system of FIG. 6 includes machine learning system 606 and intent-to-solution mapping 634. Machine learning system 606 may be configured to generate query intent 632 based on query 600, and intent-to-solution mapping 634 may be used to determine solution 640 based on query intent 632. Machine learning system 606 and intent-to-solution mapping 634 may be accessible to, may be used by, and/or may form part of a software application configured to facilitate submission and resolution of queries that describe problems.

Query 600 may include textual representation 602 of a problem experienced by a user that submitted query 600. In some cases, textual representation 602 may describe a technical problem that involves computing hardware and/or software. In some implementations, query 600 may include a representation of problem class 604, which may be one of a plurality of predefined problem classes for which technical assistance is available by way of the software application. Problem class 604 may be assigned to query 600 by the user that submitted query 600, and/or by the software application based on textual representation 602 (e.g., based on keywords present in textual representation 602). For example, each respective problem class of the plurality of predefined problem classes may be associated with a corresponding group of one or more technicians assigned to solving problems in the respective problem class. Thus, determination of problem class 604 may facilitate assigning query 600 to an appropriate technician.

Machine learning system 606 may include embedding model 608 and intent classification model 614 through intent classification model 624 (i.e., intent classification models 614-624). In some implementations, intent classification model 614 may be associated with problem class 612, intent classification model 614 may be associated with problem class 622, and other intent classification models, indicated by the ellipsis, may be associated with other problem classes of the plurality of predefined problem classes. Embedding model 608 may be shared among the plurality of predefined problem classes. Thus, embedding model 608 may be used to generate vector representation 610 independently of problem class 604, while one of intent classification models 614-624 may be selected and used based on problem class 604.

Embedding model 608 may be configured to generate vector representation 610 based on textual representation 602. Vector representation 610 may include one or more word vectors of one or more words in textual representation 602, one or more sentence vectors of one or more sentences in textual representation 602, and/or one or more paragraph vectors of one or more paragraphs in textual representation 602, among other vector representations of other possible groupings of one or more words. Vector representation 610 may include a plurality of numerical values (e.g., N values) that collectively represent a meaning of textual representation 602. In an example embodiment, embedding model 608 may include a word2vec model, an Embeddings from Language Model (ELMo), and/or a Bidirectional Encoder Representations from Transformers (BERT) model, among other possible model architectures.

Intent classification model 614 may be configured to classify queries among query intent 616 through query intent 618 (i.e., query intents 616-618) and no-solution query intent 620. Intent classification model 624 may be configured to classify queries among query intent 626 through query intent 628 (i.e., query intents 626-628) and no-solution query intent 630. Other intent classification models (indicated by the ellipsis) may be configured to classify queries among corresponding other query intents and corresponding no-solution query intents. For example, intent classification model 614 may be configured to generate, for each respective query intent of query intents 616-618 and 620, a corresponding output value (e.g., confidence value) configured to indicate a likelihood that the respective query intent represents query 600. Similarly, intent classification model 624 may be configured to generate, for each respective query intent of query intents 626-628 and 630, a corresponding output value configured to indicate a likelihood that the respective query intent represents query 600.

Query intents 616-618 may be specific to problem class 612, and query intents 626-628 may be specific to problem class 622. In some implementations, the query intents for a respective problem class may be mutually exclusive of the query intents for other problem classes. In other implementations, some problem classes may share at least one query intent. No-solution query intents 620 and 630 may each indicate that no solution is available for a query (e.g., query 600). No-solution query intent 620 and no-solution query intent 630 may differ in that each is generated by a different intent classification model based on a query associated with a different problem class.

At least one of intent classification models 614-624 may be used to generate query intent 632 based on vector representation 610. For example, in implementations where query 600 includes a representation of problem class 604, machine learning system 606 may be configured to select, from intent classification models 614-624, an intent classification model that is associated with problem class 604 (e.g., one of the intent classification models indicated by the ellipsis). In implementations where query 600 does not include a representation of problem class 604, machine learning system 606 may be configured to provide vector representation 610 as input to each of intent classification models 614-624, and query intent 632 may be selected from the output(s) of each of these models based on, for example, a confidence value associated with each output.

Machine learning system 606 may be configured to train embedding model 608 and/or intent classification models 614-624 based on a plurality of training samples. Each respective training sample of the plurality of ground-truth training samples may include at least a training textual representation (which may be similar and/or analogous to textual representation 602) and a corresponding (ground-truth) query intent. Thus, embedding model 608 and/or intent classification models 614-624 may be trained to map a plurality of different textual representations of a particular problem to a corresponding query intent, thus accounting for the variety of phrasings that different users may use to describe the particular problem. In some implementations, a plurality of ground-truth query intents may be determined for the plurality of training samples based on clustering the plurality of training samples according to the textual representations thereof. For example, the plurality of ground-truth query intents may be defined by a technician based on an analysis of the problems described in each cluster.

In some cases, a number of training samples corresponding to a particular query intent may be insufficient for training a corresponding intent classification model to achieve at least a threshold level of accuracy (e.g., 75%, 80%, 85%, etc.) with respect to the particular query intent. In cases where the number of training samples for the particular query intent is insufficient, additional training samples may be generated using a data augmentation model (not shown). The data augmentation model may be, for example, a Text to Text Transfer Transformer (T5) model. The data augmentation model may be configured to generate, based on respective textual representations corresponding to the particular query intent, additional textual representations. In generating the additional textual representations, the data augmentation may be conditioned on the particular query intent such that the additional textual representations are similar to and/or consistent with the training samples available for the particular query intent, and thus likely and/or guaranteed to, when processed by the corresponding intent classification model, map to the particular query intent.

In some implementations, each respective intent classification model of intent classification models 614-624 may include a corresponding model architecture that has been determined to perform, at least with respect to a validation data set, better than other possible architectures. Thus, intent classification models 614-624 may have different architectures. In other implementations, one or more of intent classification models 614-624 may include an ensemble of two or more models, each of which may have a different architecture and/or parameters.

The software application may be configured to use intent-to-solution mapping 634 to select solution 640 based on query intent 632. Intent-to-solution mapping 634 may include, for each respective query intent of the query intents associated with intent classification models 614-624, a corresponding solution. For example, query intents 616-618 may be mapped to solution 636 through solution 638 (i.e., solutions 636-638), and query intents 626-628 may be mapped to solution 646 through solution 648 (i.e., solutions 646-648). In implementations that group the query intents according to problem classes, solutions 636-638 may be associated with problem class 612 and solutions 646-648 may be associated with problem class 622.

Thus, the software application may be configured to select solution 640 based on solution 640 being mapped to query intent 632 as part of intent-to-solution mapping 634. In one example, if machine learning system 606 generated query intent 616 based on a first query, solution 636 would be selected as the solution to the first query. In another example, if machine learning system 606 generated query intent 628 based on a second query, solution 648 would be selected as the solution to the second query. The association of a respective solution with a corresponding query intent as part of intent-to-solution mapping 634 may indicate that the respective solution includes a valid and/or verified method, process, and/or set of operations for resolving a problem represented by the corresponding query intent. Accordingly, the presence of the corresponding query intent as a possible output of at least one of intent classification models 614-624 may indicate that a predetermined solution is available for problems associated with the corresponding query intent.

When a no-solution query intent is generated by machine learning system 606, a corresponding solution might not be provided as part of intent-to-solution mapping 634. By explicitly providing the no-solution query intent as a possible output of intent classification models 614-624, these models may be explicitly configured to distinguish between problems with documented/predetermined solutions and problems without documented/predetermined solutions. Thus, when a no-solution query intent is generated by machine learning system 606, the software application may be configured to add the corresponding query to a no-solution query set that includes queries for which intent-to-solution mapping 634 does not include a corresponding predetermined solution.

Once the no-solution query set and/or a subset (e.g., cluster or problem class) thereof accumulates at least a threshold number of unresolved queries, the software application may be configured to request a solution and a new query intent for queries in the no-solution query set and/or the subset thereof. Machine learning system 606 may be retrained based on the new query intent and the corresponding queries. Accordingly, the new query intent may be added as a possible output of at least one of intent classification models 614-624, and a mapping of the new query intent to the corresponding solution may be added to intent-to-solution mapping 634.

### VII. Example Software Application and Operations Thereof

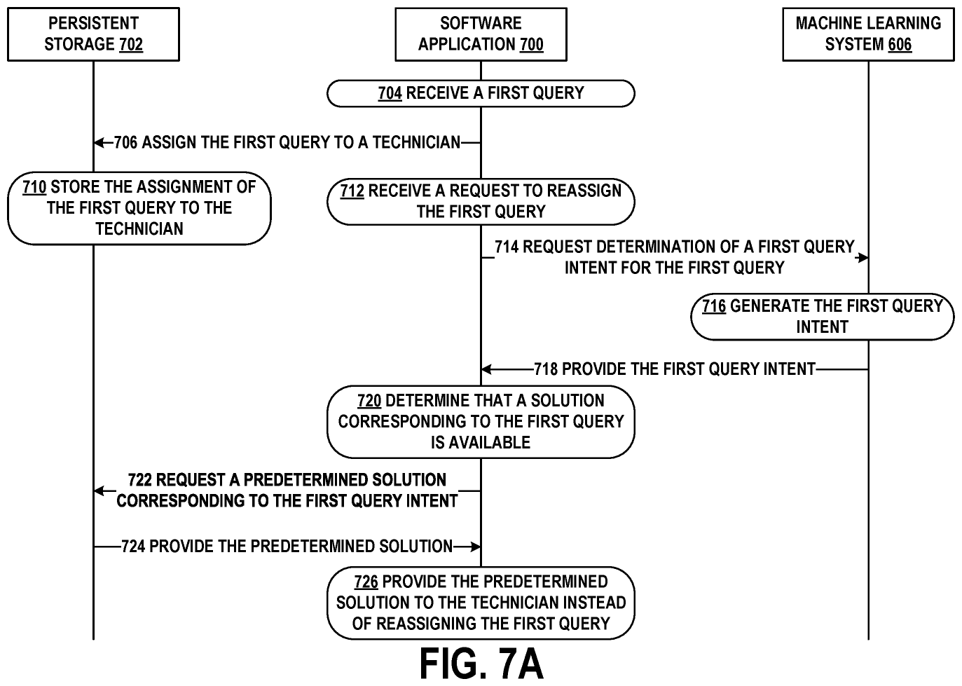

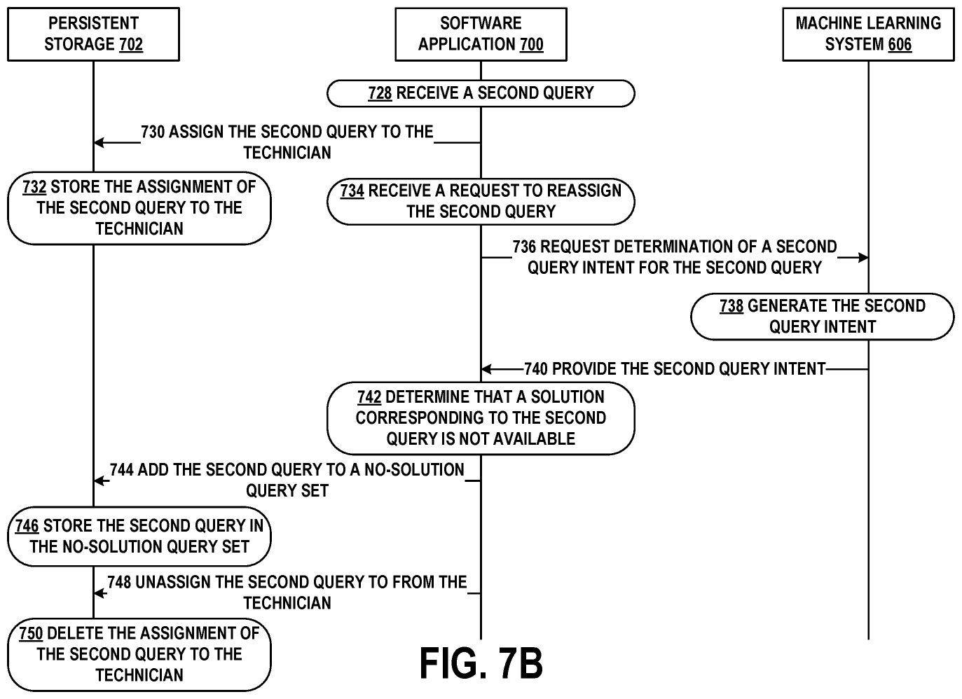

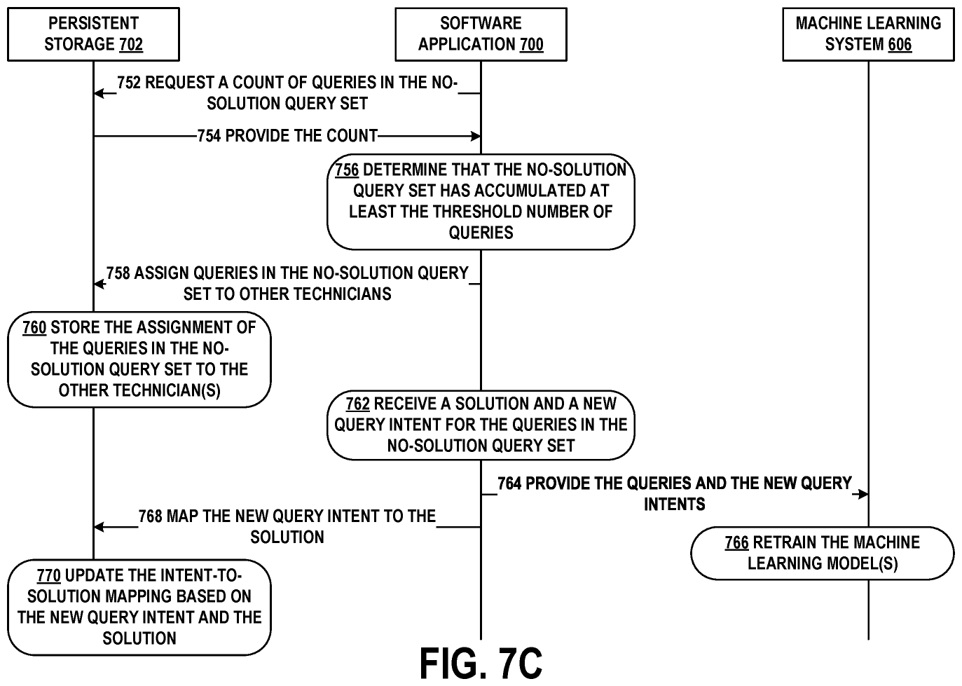

FIGS. 7A, 7B, and 7C illustrate example operations that may be carried out by a software application to facilitate resolution of problems described in user-submitted queries. FIGS. 7A, 7B, and 7C illustrate software application 700, persistent storage 702, and machine learning system, which may be disposed, for example, within remote network management platform 320 and/or managed network 300. Software application 700 may provide one or more user interfaces by way of which (i) users may submit queries and receive solutions thereto and/or (ii) technicians may view the queries, request to reassign queries, search for solutions to queries, receive suggested solutions to queries, and/or provide solutions to queries, among other possible operations. Software application 700 may represent the software application discussed in connection with FIG. 6. Persistent storage 702 may include one or more databases that store data utilized by software application 700.

Turning to FIG. 7A, software application 700 may be configured to receive a first query, as indicated by block 704. The first query received at block 704 may represent one example of query 600, and may be received (e.g., from a user) by way of the one or more user interfaces of software application 700. Thus, the first query may include a first textual representation of a first problem, and possibly also a first problem class for the first problem. Based on and/or in response to reception of the first query at block 704, software application 700 may be configured to assign the first query to a technician, as indicated by arrow 706. Based on and/or in response to reception of the assignment at arrow 706, persistent storage 702 may be configured to store the assignment of the first query to the technician, as indicated by block 710.

Storage of the assignment at block 710 may cause the first query to be added to a queue or set of queries associated with the technician. This queue or set of queries may be accessible to the technician by way of software application 700. For example, queries in the queue or set of queries may be displayed on one or more user interfaces utilized by the technician. Software application 700 may be configured to receive a request to reassign the first query, as indicated by block 712. For example, the technician may, after reviewing the textual description of the first problem contained in the first query, determine that the technician is unable to provide a solution responsive to the first query. The technician may make this determination, for example, after attempting to search for a solution in available documentation and being unable to find the solution.

Based on and/or in response to reception of the request at block 712, software application 700 may be configured to request, from machine learning system 606, determination of a first query intent for the first query, as indicated by arrow 714. The request at arrow 714 may include the first query. Based on and/or in response to reception of the request at arrow 714, machine learning system 606 may be configured to generate the first query intent, as indicated by block 716.

For example, embedding model 608 may be configured to generate a first vector representation based on the first textual representation contained in the first query. Machine learning system 606 may select one of intent classification models 614-624 based on the first problem class of the first query. The selected intent classification model may, based on the first vector representation, generate a confidence value for each of the query intents associated therewith, and the query intent associated with the highest confidence value may be selected as the first query intent for the first query.

Based on and/or in response to generation of the first query intent at block 716, machine learning system 606 may be configured to provide the first query intent to software application 700, as indicated by arrow 718. Based on and/or in response to reception of the first query intent at arrow 718, software application 700 may be configured to determine that a solution corresponding to the first query is available, as indicated by block 720. For example, software application 700 may be configured to determine that the first query intent is not a no-solution query intent, and intent-to-solution mapping 634 thus contains a mapping of a solution for the first query intent.

Based on and/or in response to determining that the solution for the first query is available, software application 700 may be configured to request, from persistent storage 702, a predetermined solution corresponding to the first query intent, as indicated by arrow 722. Based on and/or in response to reception of the request at arrow 722, persistent storage 702 may be configured to retrieve and provide the predetermined solution, as indicated by arrow 724. For example, persistent storage 702 may store intent-to-solution mapping 634, and may provide the predetermined solution by retrieving a solution that is mapped to the first query intent.

Based on and/or in response to reception of the predetermined solution at arrow 724, software application 700 may be configured to provide the predetermined solution to the technician instead of reassigning the first query, as indicated by block 726. Thus, rather than involving additional technicians by reassigning the first query, software application 700, persistent storage 702, and machine learning system 606 may operate to retrieve the predetermined solution and present it to the technician for implementation. For example, providing the predetermined solution may involve displaying the predetermined solution by way of a graphical user interface, sending a message to the technician, and/or calling the technician, among other possibilities. The predetermined solution may, for example, take the form of an excerpt of a document, and the technician may be provided with the document, the excerpt therefrom, and/or a link to the document and/or the excerpt, among other possibilities.

Accordingly, from the technician's point of view, the predetermined solution may be provided based on and/or in response to the request for reassignment of the first query at block 712. In cases where the technician is unable to implement the predetermined solution provided by software application 700 and/or determines that the predetermined solution does not solve the problem, the technician may again request to reassign the first query. Based on and/or in response to this second request for reassignment of the first query, the first query may be reassigned without involving machine learning system 606.

In some implementations, the predetermined solution may alternatively or additionally be provided directly to the user that submitted the first query. Thus, in some cases, the first problem may be resolved without involving the technician. For example, the user may be provided with the excerpt from the document, which may describe one or more steps for the user to take to implement the predetermined solution.

In some implementations, the predetermined solution may include one or more instructions executable by a computing device to cause the predetermined solution to be implemented. Thus, the technician and/or the user may be provided with a file containing the one or more instructions, and the user or technician may cause execution of the one or more instructions by opening the file. In some cases, software application 700 may be configured to automatically invoke execution of the one or more instructions, thereby implementing the solution without involving the technician and/or the user.

Turning to FIG. 7B, software application 700 may be configured to receive a second query, as indicated by block 728. The second query received at block 728 may represent another example of query 600. Thus, the second query may include a second textual representation of a second problem, and possibly also a second problem class for the second problem. Based on and/or in response to reception of the second query at block 728, software application 700 may be configured to assign the second query to a technician, as indicated by arrow 730. The technician discussed in connection with FIG. 7B may be the same as or different from the technician discussed in connection with FIG. 7A. Based on and/or in response to reception of the assignment at arrow 730, persistent storage 702 may be configured to store the assignment of the second query to the technician, as indicated by block 732.

Software application 700 may be configured to receive a request to reassign the second query, as indicated by block 734. Based on and/or in response to reception of the request at block 734, software application 700 may be configured to request, from machine learning system 606, determination of a second query intent for the second query, as indicated by arrow 736. The request at arrow 736 may include the second query. Based on and/or in response to reception of the request at arrow 736, machine learning system 606 may be configured to generate the second query intent, as indicated by block 738.

For example, embedding model 608 may be configured to generate a second vector representation based on the second textual representation contained in the second query. Machine learning system 606 may select one of intent classification models 614-624 based on the second problem class of the second query. The selected intent classification model may, based on the second vector representation, generate a confidence value for each of the query intents associated therewith, and the query intent associated with the highest confidence value may be selected as the second query intent for the second query.

Based on and/or in response to generation of the second query intent at block 738, machine learning system 606 may be configured to provide the second query intent to software application 700, as indicated by arrow 740. Based on and/or in response to reception of the second query intent at arrow 740, software application 700 may be configured to determine that a solution corresponding to the second query is not available, as indicated by block 742. For example, software application 700 may be configured to determine that the second query intent is a no-solution query intent, and intent-to-solution mapping 634 thus does not contain a mapping of a solution for the second query intent.

Based on and/or in response to determining, at block 742, that the solution corresponding to the second query is not available, software application 700 may be configured to add the second query to a no-solution query set, as indicated by arrow 744. Based on and/or in response to receiving the request at arrow 744, persistent storage 702 may be configured to store the second query in the no-solution query set, as indicated by block 746. The no-solution query set may accumulate queries for which machine learning system 606 is unable and/or not configured to determine query intents that map to corresponding predetermined solutions. In some implementations, the no-solution query set may be ordered, for example, according to the time at which queries have been added thereto. Additionally or alternatively, the no-solution query set may divide no-solution queries into multiple subsets according to their corresponding problem classes and/or based on clustering of related no-solution queries.

Additionally, based on and/or in response to determining, at block 742, that the solution corresponding to the second query is not available, software application 700 may also be configured to unassign the second query from the technician, as indicated by arrow 748. Based on and/or in response to reception of the request at arrow 748, persistent storage 702 may be configured to delete the assignment of the second query to the technician, as indicated by block 750. That is, since neither the technician not machine learning system 606 was able to identify a solution for the second problem described in the second query, the technician may no longer be expected to resolve the second problem. However, in some cases, the second query might not yet be reassigned to another technician.

Turning to FIG. 7C, software application 700 may be configured to transmit, to persistent storage 702, a request for a count of queries in the no-solution query set and/or in subset(s) thereof, as indicated by arrow 752. Based on and/or in response to reception of the request at arrow 752, persistent storage 702 may be configured to provide the count of the queries in the no-solution query set and/or the subset(s) thereof, as indicated by arrow 754. Alternatively, in some implementations, the count of the queries in the no-solution query set and/or the subset(s) thereof may be maintained and/or determined by software application 700.

Based on and/or in response to obtaining the count at arrow 754, software application 700 may be configured to determine that the no-solution query set has accumulated at least the threshold number of queries, as indicated by block 756. In some implementations, software application 700 may additionally or alternatively determine that a subset of the no-solution query set has accumulated at least the threshold number of queries (e.g., 10, 20, 50, 100, 200 or some other value depending on context and/or machine learning model). The subset of the no-solution query set may be, for example, a group of queries where each query belongs to a same problem class, and/or a cluster of queries that have similar vector representations, among other possibilities.

Based on and/or in response to the determination at block 756, software application 700 may be configured to assign the queries in the no-solution query set, and/or the subset thereof, to other technician(s), as indicated by arrow 758. Based on and/or in response to reception of the request at arrow 758, persistent storage 702 may be configured to store the assignment of the queries in the no-solution query set, and/or the subset thereof, to the other technician(s), as indicated by block 760. Assignment of the no-solution queries to the other technician(s) may operate as a request for solutions and new query intents for these queries.

In one example, the no-solution query set may be partitioned into a first plurality of subsets according to the problem class. Specifically, each subset of the first plurality of subsets may be associated with a corresponding problem class, and a given query that has been assigned the no-solution query intent may be added to a corresponding subset based on the problem class thereof. Accordingly, when a particular subset of the first plurality of subsets accumulates at least the threshold number of queries, queries of the particular subset may be assigned to the other technician(s). Thus, solutions and new query intents may be requested from the other technician(s) when a given problem class accumulates at least the threshold number of queries.

In another example, the no-solution query set may be partitioned into a second plurality of subsets according to clusters of similar queries. Specifically, each subset of the second plurality of subsets may be associated with a corresponding cluster of similar queries. A given query that has been assigned the no-solution query intent may be added to a corresponding subset based on, for example, the vector representation thereof being positioned within a threshold distance of a centroid of (or another reference point in) the corresponding cluster. Accordingly, when a particular subset of the second plurality of subsets accumulates at least the threshold number of queries, queries of the particular subset may be assigned to the other technician(s). Thus, solutions and new query intents may be requested from the other technician(s) when at least the threshold number of similar queries (which are likely to have the same or similar solution) have been accumulated.

In a further example, the no-solution query set may first be partitioned according to the problem class, and the no-solution queries of each problem class may be further partitioned according to clusters of similar queries. Accordingly, when a particular cluster of related queries associated with a given problem class accumulates at least the threshold number of queries, queries of these related queries may be assigned to the other technician(s). Similar queries that are expected to be assigned the same or similar new intent may be reassigned to the same technician, thus allowing one technician to view these similar queries and determine whether they represent the same problem (and should thus belong to the same new query intent) or different problems (and should thus belong to different new query intents).

Software application 700 may be configured to receive solutions and one or more new query intents for the queries in the no-solution query set, and/or the subset thereof, as indicated by block 762. Specifically, the solutions and one or more new query intents may be provided by the other technician(s) based on and/or in response to the queries being assigned to the other technician(s). The solution may be provided by, for example, identifying an excerpt of a document that contains the solution, and/or providing a new document that described the solution, among other possibilities.

Based on and/or in response to reception of the solution and the new queries at block 762, software application 700 may be configured to provide the queries from the no-solution set, and/or subset thereof, and the one or more new query intents to machine learning system 606, as indicated by arrow 764. Based on and/or in response to reception of the transmission of arrow 764, machine learning system 606 may be configured to retrain one or more of the machine learning models thereof, as indicated by block 766.

Specifically, machine learning system 606 may be configured to retrain at least one intent classification model of intent classification models 614-624 to additionally classify queries into the one or more new query intents. Thus, in some cases, the structure of the at least one intent classification model may be updated to include an output (e.g., an output neuron) corresponding to the new query intent. In other words, the number of output classifications for a model may be increased to incorporate the new query intent, which may be implemented as a new neuron of an output layer of a neural network in one possible example.

In some implementations, the threshold number of queries may be selected to provide a number of training samples that is sufficient for training the at least one intent classification model to achieve at least a threshold level of accuracy with respect to the new query intent. In cases where the number of training samples for the new query intent is insufficient, additional training samples may be generated using the data augmentation model, as discussed above.

Additionally, software application 700 may be configured to map the new query intent to the solution, as indicated by arrow 768. For example, the operations of arrow 768 may be executed based on and/or in response to reception of the solution and the new query intent at block 762, and/or based on and/or in response to completion of retraining of the machine learning model(s) at block 766. Based on and/or in response to reception of the request at arrow 768, persistent storage 702 may be configured to update the intent-to-solution mapping based on the new query and the solution, as indicated by block 770. For example, the new query intent and the solution may each be added to intent-to-solution mapping 634, and the new query intent may be associated with the solution.

Thus, intent-to-solution mapping 634 may be expanded over time. Specifically, by obtaining a new query intent for each new solution to one or more no-solution queries, software application 700 may increase the number of problems for which machine learning system 606 can facilitate identifying a solution. Accordingly, over time, more query reassignment requests will result in machine learning system 606 identifying a valid predetermined solution thereto, and therefore fewer technicians will be involved in addressing user-submitted queries.

### VIII. Example Operations

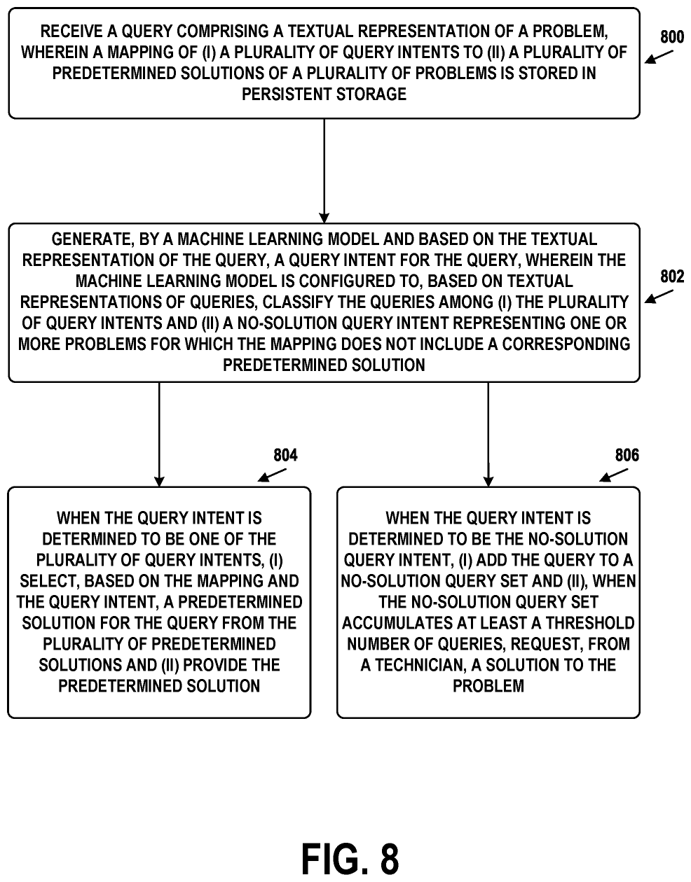

FIG. 8 is a flow chart illustrating an example embodiment. The process illustrated by FIG. 8 may be carried out by a computing device, such as computing device 100, and/or a cluster of computing devices, such as server cluster 200. However, the process can be carried out by other types of devices or device subsystems. For example, the process could be carried out by a computational instance of a remote network management platform, a portable computer, such as a laptop or a tablet device, and/or software application 700.

The embodiments of FIG. 8 may be simplified by the removal of any one or more of the features shown therein. Further, these embodiments may be combined with features, aspects, and/or implementations of any of the previous figures or otherwise described herein.

Block 800 may include receiving a query that includes a textual representation of a problem. A mapping of (i) a plurality of query intents to (ii) a plurality of predetermined solutions of a plurality of problems may be stored in persistent storage.

Block 802 may include generating, by a machine learning model and based on the textual representation of the query, a query intent for the query. The machine learning model may be configured to, based on textual representations of queries, classify the queries among (i) the plurality of query intents and (ii) a no-solution query intent representing one or more problems for which the mapping does not include a corresponding predetermined solution.

Block 804 may include, when the query intent is determined to be one of the plurality of query intents, (i) selecting, based on the mapping and the query intent, a predetermined solution for the query from the plurality of predetermined solutions and (ii) providing the predetermined solution.

Block 806 may include, when the query intent is determined to be the no-solution query intent, (i) adding the query to a no-solution query set and (ii), when the no-solution query set accumulates at least a threshold number of queries, requesting, from a technician, a solution to the problem.

In some embodiments, the query may include (i) a first query that includes a first textual representation of a first problem and (ii) a second query that includes a second textual representation of a second problem. The query intent may include (i) a first query intent, generated by the machine learning model, for the first query based on the first textual representation and (ii) a second query intent, generated by the machine learning model, for the second query based on the second textual representation. Accordingly, block 804 may include, for example, determining that the first query intent is one of the plurality of query intents and, in response, (i) selecting, based on the mapping and the first query intent, the predetermined solution for the first query from the plurality of predetermined solutions and (ii) providing the predetermined solution. Block 806 may include, determining that the second query intent is determined to be the no-solution query intent and, in response, (i) adding the second query to the no-solution query set and (ii), when the no-solution query set accumulates at least the threshold number of queries, requesting, from the technician, the solution to the second problem. Thus, in some implementations, the operations of both block 804 and 806 may be carried out, each with respect to a different query.

In some embodiments, in response to receiving the query, the query may be assigned to a second technician. Prior to resolving the problem, a request may be received to reassign the query from (i) the second technician to (ii) the technician. The query intent may be generated by the machine learning model in response to receiving the request to reassign the query. When the query intent is determined to be one of the plurality of query intents, the predetermined solution may be provided to the second technician instead of reassigning the query to the technician.

In some embodiments, when the query intent is determined to be the no-solution query intent, the query may be reassigned from the second technician to the technician.

In some embodiments, a plurality of technicians may be associated with a plurality of problem classes. The technician and the second technician may each be associated with a particular problem class of the plurality of problem classes. The problem may belong to the particular problem class. Assigning the query to the second technician may include selecting the second technician from the plurality of technicians based on the second technician being associated with the particular problem class.

In some embodiments, when the no-solution query set accumulates at least the threshold number of queries, a new query intent corresponding to the solution may be requested and/or received.

In some embodiments, the machine learning model may be retrained based on the solution and the new query intent corresponding thereto.

In some embodiments, a plurality of additional query intents may be generated for a plurality of additional queries by the machine learning model and based on respective textual representations of the plurality of additional queries. The plurality of additional query intents may be the no-solution query intent. The plurality of additional queries may be added to the no-solution query set. A plurality of query clusters present in the no-solution query set may be determined. Each respective query cluster of the plurality of query clusters may contain corresponding queries that represent a same problem or similar problems. The solution to the problem may be requested when a particular cluster of the plurality of query clusters that contains the query accumulates at least the threshold number of queries.

In some embodiments, the machine learning model may include (i) a first machine learning model that is shared by a plurality of problem classes and (ii) a plurality of machine learning models corresponding to the plurality of problem classes. Each respective machine learning model of the plurality of machine learning models may be configured to classify the queries among a corresponding subset of the plurality of query intents based on respective vectors representing the queries. The corresponding subset may include two or more query intents associated with a corresponding problem class of the plurality of problem classes. Generating the query intent may include generating, by the first machine learning model and based on the textual representation, a vector representing the query. A second machine learning model may be selected from the plurality of machine learning models based on the problem belonging to a particular problem class of the plurality of problem classes. The particular problem class may be associated with the second machine learning model. The query intent may be generated based on the vector representing the query and using the second machine learning model.

In some embodiments, the predetermined solution may include one or more instructions executable by a computing device to implement the predetermined solution. Based on providing the predetermined solution, a request to execute the one or more instructions by the computing device may be received.

In some embodiments, the predetermined solution may be described in a section of a document. Providing the predetermined solution may include providing one or more of (i) a link to the document or (ii) a representation of the section of the document.

In some embodiments, the mapping may be generated by a process that includes generating, based on respective textual representations of the plurality of problems, a plurality of clusters of the plurality of problems. For each respective cluster of the plurality of clusters, a corresponding topic of a problem subset of the plurality of problems may be identified. The problem subset may be represented by the respective cluster. For each respective cluster of the plurality of clusters and based on the corresponding topic thereof, one or more corresponding query intents of the plurality of query intents may be determined. The one or more corresponding query intents may represent the problem subset represented by the respective cluster.

In some embodiments, the machine learning model may be trained by a training process that includes determining that a number of training samples for a particular query intent of the plurality of query intents does not exceed a sample threshold. Based on determining that the number of the training samples does not exceed the sample threshold, additional training samples for the query intent may be generated using a data augmentation model and based on (i) respective textual representations of the training samples and (ii) the particular query intent. The machine learning model may be trained based on the training samples and the additional training samples.

### IX. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
persistent storage configured to store a mapping of (i) a plurality of query intents to (ii) a plurality of predetermined solutions of a plurality of problems;
a machine learning model configured to, based on textual representations of queries, classify the queries among (i) the plurality of query intents and (ii) a no-solution query intent representing one or more problems for which the mapping does not include a corresponding predetermined solution; and
a software application configured to perform operations comprising:
receiving a query comprising a textual representation of a problem;
generating, by the machine learning model and based on the textual representation of the query, a query intent for the query;
when the query intent is determined to be one of the plurality of query intents, (i) selecting, based on the mapping and the query intent, a predetermined solution for the query from the plurality of predetermined solutions and (ii) providing the predetermined solution; and
when the query intent is determined to be the no-solution query intent, (i) adding the query to a no-solution query set and (ii), when the no-solution query set accumulates at least a threshold number of queries, requesting, from a technician, a solution to the problem.

2. The system of claim 1, wherein the operations further comprise:
in response to receiving the query, assigning the query to a second technician; and
receiving, prior to resolving the problem, a request to reassign the query from (i) the second technician to (ii) the technician, wherein the query intent is generated by the machine learning model in response to receiving the request to reassign the query, and wherein, when the query intent is determined to be one of the plurality of query intents, the predetermined solution is provided to the second technician instead of reassigning the query to the technician.

3. The system of claim 2, wherein the operations further comprise:
when the query intent is determined to be the no-solution query intent, reassigning the query from the second technician to the technician.

4. The system of claim 2, wherein a plurality of technicians is associated with a plurality of problem classes, wherein the technician and the second technician are each associated with a particular problem class of the plurality of problem classes, wherein the problem belongs to the particular problem class, and wherein assigning the query to the second technician comprises:
selecting the second technician from the plurality of technicians based on the second technician being associated with the particular problem class.

5. The system of claim 1, wherein the operations further comprise:
when the no-solution query set accumulates at least the threshold number of queries, requesting a new query intent corresponding to the solution.

6. The system of claim 5, wherein the operations further comprise:
retraining the machine learning model based on the solution and the new query intent corresponding thereto.

7. The system of claim 1, wherein the operations further comprise:
generating, by the machine learning model and based on respective textual representations of a plurality of additional queries, a plurality of additional query intents for the plurality of additional queries, wherein the plurality of additional query intents are the no-solution query intent;
adding the plurality of additional queries to the no-solution query set; and
determining a plurality of query clusters present in the no-solution query set, wherein each respective query cluster of the plurality of query clusters contains corresponding queries that represent a same problem or similar problems, and wherein the solution to the problem is requested when a particular cluster of the plurality of query clusters that contains the query accumulates at least the threshold number of queries.

8. The system of claim 1, wherein the machine learning model comprises (i) a first machine learning model that is shared by a plurality of problem classes and (ii) a plurality of machine learning models corresponding to the plurality of problem classes, wherein each respective machine learning model of the plurality of machine learning models is configured to classify the queries among a corresponding subset of the plurality of query intents based on respective vectors representing the queries, wherein the corresponding subset comprises two or more query intents associated with a corresponding problem class of the plurality of problem classes, and wherein generating the query intent comprises:
generating, by the first machine learning model and based on the textual representation, a vector representing the query;
selecting a second machine learning model from the plurality of machine learning models based on the problem belonging to a particular problem class of the plurality of problem classes, wherein the particular problem class is associated with the second machine learning model; and
generating, based on the vector representing the query and using the second machine learning model, the query intent.

9. The system of claim 1, wherein the predetermined solution comprises one or more instructions executable by a computing device to implement the predetermined solution, and wherein the operations further comprise:
based on providing the predetermined solution, receiving a request to execute the one or more instructions by the computing device.

10. The system of claim 1, wherein the predetermined solution is described in a section of a document, and wherein providing the predetermined solution comprises:
providing one or more of (i) a link to the document or (ii) a representation of the section of the document.

11. The system of claim 1, wherein the operations further comprise generating the mapping by:
generating, based on respective textual representations of the plurality of problems, a plurality of clusters of the plurality of problems;
identifying, for each respective cluster of the plurality of clusters, a corresponding topic of a problem subset of the plurality of problems, wherein the problem subset is represented by the respective cluster; and
determining, for each respective cluster of the plurality of clusters and based on the corresponding topic thereof, one or more corresponding query intents of the plurality of query intents, wherein the one or more corresponding query intents represent the problem subset represented by the respective cluster.

12. The system of claim 1, wherein the operations further comprise training the machine learning model by:
determining that a number of training samples for a particular query intent of the plurality of query intents does not exceed a sample threshold;
based on determining that the number of the training samples does not exceed the sample threshold, generating, using a data augmentation model and based on (i) respective textual representations of the training samples and (ii) the particular query intent, additional training samples for the query intent; and
training the machine learning model based on the training samples and the additional training samples.

13. A method comprising:
receiving a query comprising a textual representation of a problem, wherein a mapping of (i) a plurality of query intents to (ii) a plurality of predetermined solutions of a plurality of problems is stored in persistent storage;
generating, by a machine learning model and based on the textual representation of the query, a query intent for the query, wherein the machine learning model is configured to, based on textual representations of queries, classify the queries among (i) the plurality of query intents and (ii) a no-solution query intent representing one or more problems for which the mapping does not include a corresponding predetermined solution;
when the query intent is determined to be one of the plurality of query intents, (i) selecting, based on the mapping and the query intent, a predetermined solution for the query from the plurality of predetermined solutions and (ii) providing the predetermined solution; and
when the query intent is determined to be the no-solution query intent, (i) adding the query to a no-solution query set and (ii), when the no-solution query set accumulates at least a threshold number of queries, requesting, from a technician, a solution to the problem.

14. The method of claim 13, further comprising:
in response to receiving the query, assigning the query to a second technician; and
receiving, prior to resolving the problem, a request to reassign the query from (i) the second technician to (ii) the technician, wherein the query intent is generated by the machine learning model in response to receiving the request to reassign the query, and wherein, when the query intent is determined to be one of the plurality of query intents, the predetermined solution is provided to the second technician instead of reassigning the query to the technician.

15. The method of claim 14, further comprising:
when the query intent is determined to be the no-solution query intent, reassigning the query from the second technician to the technician.

16. The method of claim 13, further comprising:
when the no-solution query set accumulates at least the threshold number of queries, requesting a new query intent corresponding to the solution.

17. The method of claim 16, further comprising:
retraining the machine learning model based on the solution and the new query intent corresponding thereto.

18. The method of claim 13, further comprising:
generating, by the machine learning model and based on respective textual representations of a plurality of additional queries, a plurality of additional query intents for the plurality of additional queries, wherein the plurality of additional query intents are the no-solution query intent;
adding the plurality of additional queries to the no-solution query set; and
determining a plurality of query clusters present in the no-solution query set, wherein each respective query cluster of the plurality of query clusters contains corresponding queries that represent a same problem or similar problems, and wherein the solution to the problem is requested when a particular cluster of the plurality of query clusters that contains the query accumulates at least the threshold number of queries.

19. The method of claim 13, wherein the machine learning model comprises (i) a first machine learning model that is shared by a plurality of problem classes and (ii) a plurality of machine learning models corresponding to the plurality of problem classes, wherein each respective machine learning model of the plurality of machine learning models is configured to classify the queries among a corresponding subset of the plurality of query intents based on respective vectors representing the queries, wherein the corresponding subset comprises two or more query intents associated with a corresponding problem class of the plurality of problem classes, and wherein generating the query intent comprises:
generating, by the first machine learning model and based on the textual representation, a vector representing the query;
selecting a second machine learning model from the plurality of machine learning models based on the problem belonging to a particular problem class of the plurality of problem classes, wherein the particular problem class is associated with the second machine learning model; and
generating, based on the vector representing the query and using the second machine learning model, the query intent.

20. An article of manufacture including a non-transitory computer-readable medium, having stored thereon program instructions that, upon execution by a computing system, cause the computing system to perform operations comprising:
receiving a query comprising a textual representation of a problem, wherein a mapping of (i) a plurality of query intents to (ii) a plurality of predetermined solutions of a plurality of problems is stored in persistent storage;
generating, by a machine learning model and based on the textual representation of the query, a query intent for the query, wherein the machine learning model is configured to, based on textual representations of queries, classify the queries among (i) the plurality of query intents and (ii) a no-solution query intent representing one or more problems for which the mapping does not include a corresponding predetermined solution;
when the query intent is determined to be one of the plurality of query intents, (i) selecting, based on the mapping and the query intent, a predetermined solution for the query from the plurality of predetermined solutions and (ii) providing the predetermined solution; and
when the query intent is determined to be the no-solution query intent, (i) adding the query to a no-solution query set and (ii), when the no-solution query set accumulates at least a threshold number of queries, requesting, from a technician, a solution to the problem.
